(19) United States
(12) Patent Application Publication
(10) Pub. No.: US 2025/0336231 A1
(43) Pub. Date: Oct. 30, 2025

(54) INFORMATION PROMPT METHOD AND APPARATUS, AND COMPUTER DEVICE AND STORAGE MEDIUM

(71) Applicant: Beijing Zitiao Network Technology Co., Ltd., Beijing (CN)

(72) Inventors: Qiang ZHOU, Beijing (CN); Chengyi WANG, Beijing (CN); Kaikai REN, Beijing (CN); Siying CHEN, Beijing (CN)

(21) Appl. No.: 19/260,107

(22) Filed: Jul. 3, 2025

Related U.S. Application Data
(63) Continuation of application No. PCT/CN2023/137843, filed on Dec. 11, 2023.

(30) Foreign Application Priority Data
Jan. 6, 2023 (CN) 202310018780.1

(51) Int. Cl. G06V 40/16; G06T 7/00; G06V 10/26; G06V 10/44; G06V 10/56; G09B 21/00

(52) U.S. Cl. CPC G06V 40/162; G06T 7/0012; G06V 10/26; G06V 10/457; G06V 10/56; G09B 21/006; G06T 2207/10024; G06T 2207/30088; G06T 2207/30201

(57) ABSTRACT

Provided in the present disclosure are an information prompt method and apparatus, and a computer device and a storage medium. The method comprises: obtaining a to-be-detected image; parsing the to-be-detected image to generate a mask image; detecting a makeup effect of a target part in the to-be-detected image based on the mask image and the to-be-detected image to obtain a makeup detection result of the target part; and generating prompt information based on the makeup detection result of the target part, and playing the prompt information.

### CROSS-REFERENCE TO RELATED APPLICATION(S)

The present application is a continuation of International Application No. PCT/CN2023/137843, as filed on Dec. 11, 2023, which is based on and claims the priority to the Chinese application No. 202310018780.1 filed on Jan. 6, 2023, titled “INFORMATION PROMPT METHOD AND APPARATUS, AND COMPUTER DEVICE AND STORAGE MEDIUM”, the disclosure of the applications are incorporated by reference herein in their entireties.

### TECHNICAL FIELD

The present disclosure relates to the field of image processing technologies, and specifically to an information prompt method and apparatus, and a computer device and a storage medium.

### BACKGROUND

Makeup has become a part of people's daily life, wherein makeup is a process of rendering and painting eyes, eyebrows and other parts on a face according to specific steps by using cosmetics, makeup tools and the like, so as to increase three-dimensional appearance of facial features, thereby beautifying visual perception.

There are some vision-impaired persons in real life, and the vision-impaired persons also have need for makeup and perform makeup operations in life, but makeup effects of the vision-impaired persons might be abnormal, so that how to enable vision-impaired persons to know their own makeup effects without manual prompts is a subject worthy of study.

### SUMMARY

Embodiments of the present disclosure at least provide an information prompt method and apparatus, and an electronic device and a storage medium.

In a first aspect, an embodiment of the present disclosure provides an information prompt method, including:
obtaining a to-be-detected facial image;
parsing the to-be-detected facial image to generate a facial mask image;
detecting a makeup effect of a target part in the to-be-detected facial image based on the facial mask image and the to-be-detected facial image to obtain a makeup detection result of the target part; and
generating prompt information based on the makeup detection result of the target part, and playing the prompt information.

In an optional implementation, in a case where the target part includes a lip part, the detecting the makeup effect of the target part in the to-be-detected facial image based on the facial mask image and the to-be-detected facial image to obtain the makeup detection result of the target part, includes:
performing format conversion processing on the to-be-detected facial image to generate a processed facial image with a luminance chrominance format;
determining a target pixel point in the processed facial image that has pixel information matched with target color information, and determining region information of a to-be-detected region corresponding to a target color in the to-be-detected facial image based on a pixel position of the target pixel point; and
detecting a makeup effect of the lip part in the to-be-detected facial image based on the region information of the to-be-detected region and mask region information corresponding to the lip part in the facial mask image to obtain a makeup detection result of the lip part.

In an optional implementation, the detecting the makeup effect of the lip part in the to-be-detected facial image based on the region information of the to-be-detected region and the mask region information corresponding to the lip part in the facial mask image to obtain the makeup detection result of the lip part, includes:
determining whether a deviation region exists between the to-be-detected region and a mask region corresponding to the lip part based on the region information of the to-be-detected region and the mask region information corresponding to the lip part in the facial mask image;
if the deviation region exists, determining a target local region where the deviation region is located based on region information of the deviation region and region information of a plurality of local regions obtained by partitioning the lip part; and
generating the makeup detection result of the lip part based on region information of the target local region.

In an optional implementation, in a case where the target part includes an eyeline part and/or an eyebrow part, the detecting the makeup effect of the target part in the to-be-detected facial image based on the facial mask image and the to-be-detected facial image to obtain the makeup detection result of the target part, includes:
performing edge detection on the to-be-detected facial image to generate a facial contour image, where the facial contour image indicates contour information of a facial part;
determining deviation contour information based on first contour information of the target part indicated by the facial contour image and second contour information of the target part indicated by the facial mask image; and
generating the makeup detection result of the target part based on the deviation contour information

In an optional implementation, the generating the makeup detection result of the target part based on the deviation contour information, includes:
determining a size value of the target part in a target direction based on the facial mask image;
determining a ratio between a deviation value indicated by the deviation contour information and the size value; and
generating the makeup detection result of the target part based on the ratio.

In an optional implementation, in a case where the target part includes a facial part other than five sense organs within a face, the detecting the makeup effect of the target part in the to-be-detected facial image based on the facial mask image and the to-be-detected facial image to obtain the makeup detection result of the target part, includes:
determining reference pixel information corresponding to the facial part based on the to-be-detected facial image and a mask region of the facial part indicated by the facial mask image;
determining abnormal pixel information characterizing a makeup abnormality state of the facial part based on the reference pixel information;
performing connected domain detection on the to-be-detected facial image based on the abnormal pixel information to determine whether the to-be-detected facial image includes a connected domain; and
if the connected domain is included, generating a makeup detection result of the facial part based on region information of the connected domain on the to-be-detected facial image.

In an optional implementation, after the obtaining the to-be-detected facial image, the method further includes:
performing skin quality evaluation on the to-be-detected facial image to generate a skin detection result; and
generating recommendation information based on the skin detection result, and playing the recommendation information.

In an optional implementation, the obtaining the to-be-detected facial image, includes:
acquiring an initial facial image of a target user;
when a head region in the initial facial image is located within a preset region, playing makeup guidance information; and
during playing the makeup guidance information, or after finishing playing the makeup guidance information, obtaining a facial image of the target user to use the facial image as the to-be-detected facial image.

In a second aspect, an embodiment of the present disclosure further provides an information prompting apparatus, including:
an obtaining module configured to obtain a to-be-detected facial image;
a first generation module configured to parse the to-be-detected facial image to generate a facial mask image;
a detection module configured to detect a makeup effect of a target part in the to-be-detected facial image based on the facial mask image and the to-be-detected facial image to obtain a makeup detection result of the target part; and
a second generation module configured to generate prompt information based on the makeup detection result of the target part, and play the prompt information.

In a third aspect, an embodiment of the present disclosure further provides a computer device, including: a processor, a memory and a bus, the memory having thereon stored machine-readable instructions executable by the processor, the processor communicating with the memory via the bus when the computer device runs, and the machine-readable instructions, when executed by the processor, performing the steps in the first aspect described above or in any of the possible implementations in the first aspect.

In a fourth aspect, an embodiment of the present disclosure further provides a computer-readable storage medium having thereon stored a computer program which, when executed by a processor, performs the steps in the first aspect described above or in any of the possible implementations in the first aspect.

In a fifth aspect, an embodiment of the present disclosure further provides a computer program product, including: instructions which, when executed by a processor, cause the processor to perform the steps in the first aspect described above or in any of the possible implementations in the first aspect.

In a sixth aspect, an embodiment of the present disclosure further provides a computer program, including: instructions which, when executed by a processor, cause the processor to perform the steps in the first aspect described above or any of the possible implementations in the first aspect.

Meanwhile, considering that this method can be used for vision-impaired persons, the prompt information is played by voice to meet the requirements of the vision-impaired persons to understand their own makeup effects.

In order to make the above objectives, features and advantages of the present disclosure more obvious and understandable, preferred embodiments are specifically provided and detailed description in conjunction with the accompanying drawings is made below.

### BRIEF DESCRIPTION OF THE DRAWINGS

In order to more clearly illustrate the technical solutions of the embodiments of the present disclosure, the drawings be used in the embodiments will be briefly described below, and the drawings herein are incorporated in and form a part of the specification; these drawings illustrate embodiments consistent with the present disclosure and, together with the description, serve to explain the technical solutions of the present disclosure. It should be understood that the following drawings illustrate only certain embodiments of the present disclosure and therefore should not be considered as limitations on the scope, and for one of ordinary skill in the art, other related drawings may be obtained according to these drawings without paying creative labor.

FIG. 1 illustrates a flow diagram of an information prompt method according to an embodiment of the present disclosure;

FIG. 2a illustrates a schematic diagram of a result of partitioning a lip part in the information prompt method according to the embodiment of the present disclosure;

FIG. 2b illustrates a schematic diagram of another result of partitioning a lip part in the information prompt method according to the embodiment of the present disclosure;

FIG. 3 illustrates a schematic diagram of a facial contour image in the information prompt method according to the embodiment of the present disclosure;

FIG. 4 illustrates a flow diagram of another information prompt method according to an embodiment of the present disclosure;

FIG. 5 illustrates a flow diagram of another information prompt method according to an embodiment of the present disclosure;

FIG. 6 illustrates a schematic structural diagram of an information prompt apparatus according to an embodiment of the present disclosure;

FIG. 7 illustrates a schematic structural diagram of a computer device according to an embodiment of the present disclosure.

### DETAILED DESCRIPTION

To make the objectives, technical solutions and advantages of the embodiments of the present disclosure more apparent, the technical solutions in the embodiments of the present disclosure will be described clearly and completely in conjunction with the drawings in the embodiments of the present disclosure, and it is obvious that the described embodiments are only some of the embodiments of the present disclosure, rather than all of the embodiments. Generally, components of the embodiments of the present disclosure that are described and illustrated in the drawings herein may be arranged and designed in various different configurations. Therefore, the following detailed description made to the embodiments of the present disclosure that are provided in the drawings is not intended to limit the claimed scope of the present disclosure, but merely represents selected embodiments of the present disclosure. All other embodiments, which are obtained by those skilled in the art based on the embodiments of the present disclosure without making creative labor, shall fall within the scope of protection of the present disclosure.

There are some vision-impaired persons in real life, and the vision-impaired persons have requirements for makeup and also perform makeup operations in life, but makeup effects of the vision-impaired persons might be abnormal, so that how to enable the vision-impaired persons to understand their own makeup effects without manual prompts is a subject worthy of study.

Based on this, the present disclosure provides an information prompt method and apparatus, and an electronic device and a storage medium, in the method, after a to-be-detected facial image is obtained, the to-be-detected facial image is parsed to generate a facial mask image, which can indicate a position of each part on a face, and then based on the facial mask image and the to-be-detected facial image, a makeup effect of a target part in the to-be-detected facial image is detected to obtain a makeup detection effect of the target part, and prompt information is generated based on the makeup detection result of the target part and played, so that a user can have a clear understanding of his own makeup effect based on the prompt information, achieving automatic detection of the makeup. Meanwhile, considering that this method can be used for vision-impaired persons, the prompt information is played by voice to meet the requirements of the vision-impaired persons to understand their own makeup effects.

It should be noted that: similar reference numbers and letters refer to similar items in the following figures, and thus, once a certain item is defined in one figure, it need not be further defined or explained in subsequent figures.

The term “and/or” herein, which merely describes a relationship of association, indicates the existence of three possible relationships. For instance, A and/or B can indicate: the existence of A alone, the coexistence of A and B, or the existence of B alone. In addition, the term “at least one” herein indicates any one or any combination of at least two of a plurality, for example, including at least one of A, B, or C can represent including any single or multiple elements selected from a group consisting of A, B and C.

It can be understood that, before the technical solutions disclosed in the embodiments of the present disclosure are used, a user should be informed of a type, a usage scope, a usage scenario, etc. of personal information involved in the present disclosure in a proper manner according to related laws and regulations, and authorization from the user should be obtained.

For example, in response to receiving an active request from a user, prompt information is sent to the user to explicitly prompt the user that an operation he requests to be performed would require obtaining and using personal information of the user. Therefore, this enables the user to autonomously select whether to provide the personal information to software or hardware that performs operations of the technical solution of the present disclosure, such as an electronic device, an application, a server, or a storage medium, based on the prompt information.

As an optional but non-limiting implementation, in response to receiving an active request from a user, prompt information may be sent to the user in the form of a pop-up window, and the pop-up window can display the prompt information in text form. In addition, a selection control can also be provided in the pop-up window, for the user to select “agree” or “disagree” to provide personal information to the electronic device.

It can be understood that the above processes of notification and obtaining authorization from the user are only illustrative and are not intended to limit the implementation of the present disclosure, and other manners satisfying with the related laws and regulations may be applied to the implementation of the present disclosure.

To facilitate understanding of this embodiment, first, an information prompt method disclosed in an embodiment of the present disclosure is described in detail, and an execution subject of the information prompt method provided in the embodiment of the present disclosure is generally a computer device with a certain computing capability, which includes, for example: a mobile phone, tablet, computer and the like. In some possible implementations, this information prompt method may be implemented by a processor calling computer-readable instructions stored in a memory.

The information prompt method provided in the embodiment of the present disclosure is described below by taking an example that the execution subject is a terminal device.

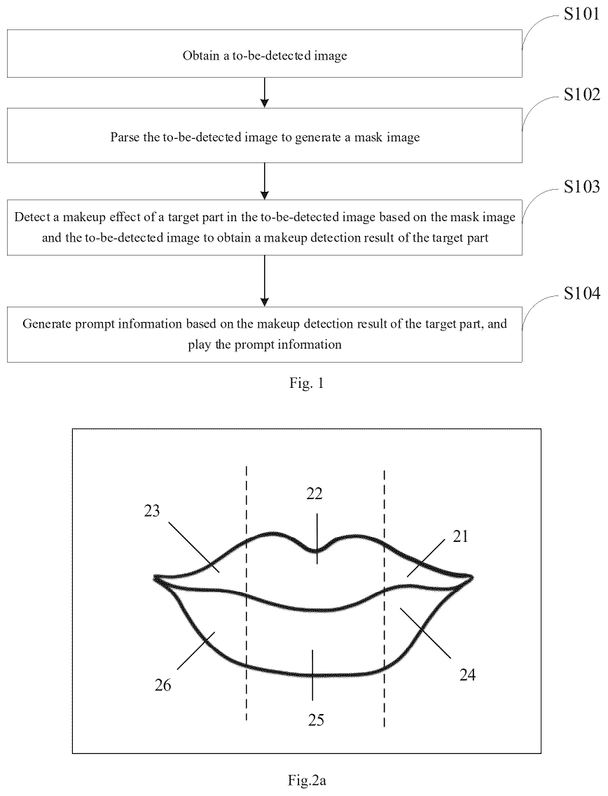

Referring to FIG. 1, it is a flow diagram of the information prompt method according to the embodiment of the present disclosure, the method including S101 to S104:
S101, obtaining a to-be-detected facial image;
S102, parsing the to-be-detected facial image to generate a facial mask image;
S103, detecting a makeup effect of a target part in the to-be-detected facial image based on the facial mask image and the to-be-detected facial image to obtain a makeup detection result of the target part; and
S104, generating prompt information based on the makeup detection result of the target part, and playing the prompt information.

S101 to S104 will be specifically described below.

In the S101, the to-be-detected facial image may be an image including a face of a user, the user may be a vision-normal person or a vision-impaired person, which is not specifically limited in this solution. Exemplarily, a facial image of the user may be acquired by using a mobile device with a camera, such as a mobile phone, a tablet, and be used as the to-be-detected facial image.

In specific implementation, the obtaining the to-be-detected facial image may include: acquiring an initial facial image of a target user; when a head region in the initial facial image is located within a preset region, playing makeup guidance information; and during playing the makeup guidance information or after finishing playing the makeup guidance information, obtaining a facial image of the target user to use the facial image as the to-be-detected facial image.

An initial facial image of a target user is acquired, and facial detection on the initial facial image is performed to determine a real-time position of a head region in the initial facial image, where the real-time position can be coordinate information of a detection box for the head region. And based on the real-time position of the head region, it is determined whether the head region is located within a preset region, for example, it can be determined whether the head region is completely located within the preset region, and if so, it is determined that the head region is located within the preset region.

If it is determined that the head region is located within the preset region, makeup guidance information is played; otherwise, position adjustment information may be generated and played, for example, the position adjustment information may be “move leftwards”, “move upwards”, or the like, so that the target user can adjust the head region based on the position adjustment information, to make the head region located within the preset region of the initial facial image. The preset region may be a central region of the initial facial image, exemplarily, the preset region may be obtained based on a preset size and shape by using a central point of the initial facial image as a reference, for example, a circular region may be obtained by using the central point as a circle center and a preset length as a radius, and be used as the preset region.

The makeup guidance information may include, but is not limited to, eyebrow makeup guidance information, eyeline makeup guidance information, lipstick makeup guidance information, blusher makeup guidance information, facial foundation makeup guidance information, and the like. In consideration of inconvenience of the target user who are visually impaired, when a plurality of kinds of makeup guidance information are included, a playing order among the plurality of kinds of makeup guidance information may be preset, and the makeup guidance information may be played in the determined playing order, so that the target user can perform a makeup operation based on the played makeup guidance information.

In the process of playing the makeup guidance information, a facial image of the target user can be obtained based on a set time interval to use the facial image as the to-be-detected facial image, where the time interval can be set according to an application scene. Alternatively, after finishing playing the makeup guidance information, a facial image of the target user may be obtained to use the facial image as the to-be-detected facial image.

Here, by detecting the position of the head region in the initial facial image to determine that the head region in the initial facial image is located within the preset region, and playing the makeup guidance information, it can be ensured that a subsequently obtained to-be-detected facial image includes the complete face of the target user, to improve the detection precision of the makeup effect.

In the S102, after the to-be-detected facial image is obtained, the to-be-detected facial image may be parsed to generate a facial mask image, pixel points located in different part regions in the facial mask image having different pixel values, where the facial mask image may have the same size as the to-be-detected facial image. For example, a pixel point in an eye part region in the facial mask image has a pixel value of s1, a pixel point in a lip part region has a pixel value of s2, and the like, so that the facial mask image can indicate a position of a region where each part in the to-be-detected facial image is located.

In specific implementation, the to-be-detected facial image may be parsed by using a face segmentation algorithm to generate the facial mask image. Alternatively, the to-be-detected facial image may be parsed by using a face segmentation tool such as an open-source face-parsing tool, to generate the facial mask image.

In the S103, based on a region position of the target part indicated by the facial mask image, a region image matched with the region position in the to-be-detected facial image may be determined, and the region image is detected to determine a makeup detection result of the target part. For example, a makeup contour of the target part in the region image can be detected, and if a deviation between the makeup contour and a contour of the target part is small, it is determined that the makeup detection result is that the makeup for the target part is normal; otherwise, the makeup detection result is that the makeup for the target part is abnormal. The target part may, for example, include one or more of the following: a lip part, an eyeline part, an eyebrow part, a facial part other than five sense organs, etc.; and the makeup effect may include a makeup contour, a makeup color, makeup evenness, and the like.

In one manner, in a case where the target part includes a lip part, the detecting the makeup effect of the target part in the to-be-detected facial image based on the facial mask image and the to-be-detected facial image to obtain the makeup detection result of the target part, includes:
step A1, performing format conversion processing on the to-be-detected facial image to generate a processed facial image with a luminance chrominance (YUV) format;
step A2, determining a target pixel point in the processed facial image that has pixel information matched with target color information, and determining region information of a to-be-detected region corresponding to a target color in the to-be-detected facial image based on a pixel position of the target pixel point; and
step A3, detecting a makeup effect of the lip part in the to-be-detected facial image based on the region information of the to-be-detected region and mask region information corresponding to the lip part in the facial mask image to obtain a makeup detection result of the lip part.

In the step A1, considering that makeup for the lip part is to apply lipstick, which has a bright color, since an image in the YUV format is more sensitive to color, format conversion processing may be performed on the to-be-detected facial image to generate the processed facial image with the YUV format. For example, if the to-be-detected facial image is an image in a red-green-blue (RGB) format, the to-be-detected facial image may be converted from the RGB format to the YUV format to generate a processed facial image.

In the step A2, the target color information may be color information related to the lip part, such as red color information, rose red color information. The target pixel point in the processed facial image that has pixel information matched with target color information is determined, and region information of a to-be-detected region corresponding to a target color in the to-be-detected facial image is determined based on a pixel position of the target pixel point in the processed facial image. The to-be-detected region can be a region where lipstick is applied, and the region information can be position information of the to-be-detected region on the to-be-detected facial image.

In the step A3, based on the region information of the to-be-detected region and the mask region information of the lip part in the facial mask image, a deviation region between the to-be-detected region and a mask region of the lip part is determined, and the makeup effect of the lip part is detected based on region information of the deviation region to obtain the makeup detection effect of the lip part. For example, region area of the deviation region may be determined, and if the region area is large, it is determined that the makeup detection effect of the lip part is that the makeup is abnormal. Alternatively, it may be determined whether the deviation region is located at the lip part based on the region information of the deviation region, if so, makeup may not be performed on the deviation region, so that it is determined that the makeup detection result of the lip part is that the makeup is normal; otherwise, the deviation region is makeup out-of-bound of the lip part, so that it is determined that the makeup detection result of the lip part is that the makeup is abnormal.

Here, by performing format conversion processing on the to-be-detected facial image to obtain the processed facial image in the YUV format, the target pixel point matched with the target color can be determined more accurately based on the processed facial image, i.e., the region information of the to-be-detected region for which makeup processing is made can be obtained more accurately; and then, based on the region information of the to-be-detected region and the mask region information corresponding to the lip part in the facial mask image, the makeup effect of the lip part in the to-be-detected facial image is detected, so that the makeup detection result of the lip part can be accurately obtained, improving the makeup detection precision of the lip part.

In an optional implementation, in the step A3, the detecting the makeup effect of the lip part in the to-be-detected facial image based on the region information of the to-be-detected region and the mask region information corresponding to the lip part in the facial mask image to obtain the makeup detection result of the lip part, includes: determining whether a deviation region exists between the to-be-detected region and a mask region corresponding to the lip part based on the region information of the to-be-detected region and the mask region information corresponding to the lip part in the facial mask image; if the deviation region exists, determining a target local region where the deviation region is located based on region information of the deviation region and region information of a plurality of local regions obtained by partitioning the lip part; and generating the makeup detection result of the lip part based on region information of the target local region.

In implementation, corresponding pixel position subtraction operation may be performed on the region information of the to-be-detected region and the mask region information corresponding to the lip part in the facial mask image, to determine whether the deviation region exists between the to-be-detected region and the mask region of the lip part. If the deviation region exists, the target local region where the deviation region is located is determined based on the region information of the deviation region and the region information of the plurality of local regions obtained by partitioning the lip part.

Referring to FIG. 2a where the lip part is partitioned into a plurality of local regions, for example, six local regions, it can be seen that the lip part is partitioned into a first local region 21 located at an upper left corner, a second local region 22 located at an upper middle, a third local region 23 located at an upper right corner, a fourth local region 24 located at a lower left corner, a fifth local region 25 located at a lower middle, and a sixth local region 26 located at a lower right corner.

Exemplarily, if it is determined that the deviation region is located in the first local region at the upper left corner (i.e., target local region), the makeup detection result of the lip part is generated based on region information of the target local region, for example, the makeup detection result may be “abnormal at the upper left corner of the lip”.

Referring to FIG. 2b where the lip part is partitioned into a plurality of local regions, for example, 12 local regions, i.e., local regions c1, c2, c3, c4, c5, c6, c7, c8, c9, c10, c11, and c12. Then, if it is determined that the deviation region is located in the local region c3, the makeup detection result may be “edge exceeded at the upper left corner of the lips”. If it is determined that the deviation region is located in the local region c5, the makeup test result may be “not fully applied in the upper middle region of the lip”.

In specific implementation, after the existence of the deviation region is determined, region area of the deviation region may be also determined, if the region area is greater than a set area threshold, the target local region where the deviation region is located is determined, and the makeup detection result of the lip part is generated based on the region information of the target local region.

Here, the lip part can be partitioned to obtain the region information of the plurality of local regions, the target local region where the deviation region is located can be determined, and the makeup detection result can be accurately generated based on the region information of the target local region.

In another manner, in a case where the target part includes an eyeline part and/or an eyebrow part, the detecting the makeup effect of the target part in the to-be-detected facial image based on the facial mask image and the to-be-detected facial image to obtain the makeup detection result of the target part, includes:
step B1, performing edge detection on the to-be-detected facial image to generate a facial contour image, where the facial contour image indicates contour information of a facial part;
step B2, determining deviation contour information based on first contour information of the target part indicated by the facial contour image and second contour information of the target part indicated by the facial mask image; and
step B3, generating the makeup detection result of the target part based on the deviation contour information.

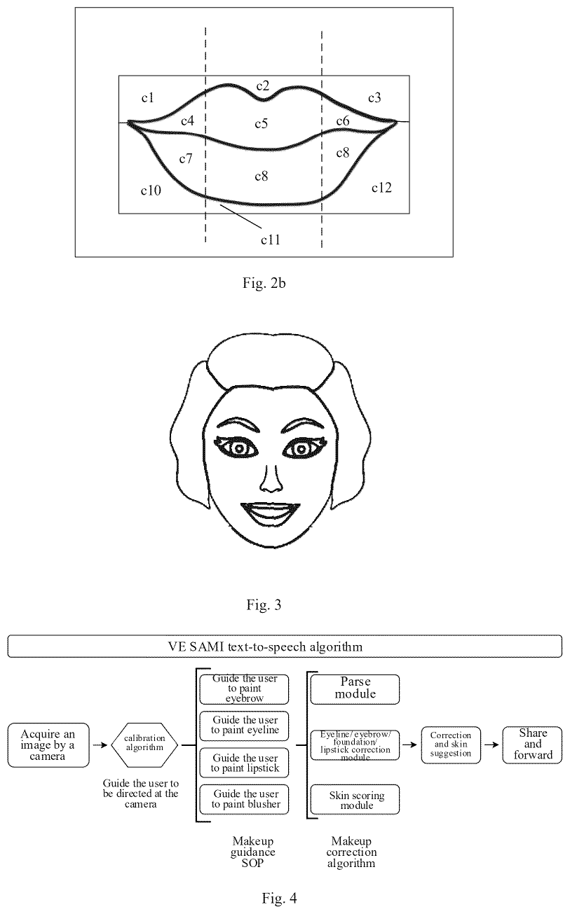

In the step B1, edge detection may be performed on the to-be-detected facial image to generate the facial contour image, for example, the edge detection may be performed on the to-be-detected facial image by using an edge contour detection algorithm to generate the facial contour image, where the facial contour image indicates the contour information of the facial part. See a facial contour image shown in FIG. 3. If makeup is performed on an eyebrow part, a contour of the eyebrow part in the facial contour image corresponds to a contour of an eyebrow after the makeup. If an eyeline is painted on an eye part, a contour of the eye part corresponds to a contour of an eye having the eyeline painted thereon.

In the step B2, when the target part is an eyeline part, a corresponding pixel position subtraction operation may be performed on the first contour information of the target part indicated by the facial contour image and the second contour information of the target part indicated by the facial mask image to generate the deviation contour information. The deviation contour may be an eyeline contour at an eye end.

In the step B3, the makeup detection result of the target part may be generated based on the deviation contour information, for example, a deviation length indicated by the deviation contour information may be determined, and if the deviation length is greater than a set deviation threshold, it is determined that the makeup detection result of the target part is that the makeup is abnormal, otherwise, the makeup detection result of the target part is that the makeup is normal.

In implementation, symmetry between a left eyeline and a right eyeline can also be detected, for example, it is determined whether a contour of a left eye and a contour of a right eye in the facial contour image are symmetric, and if so, the makeup detection result is that the makeup is normal; if not, the makeup detection result is that the makeup is abnormal. And symmetry between a left eyebrow and a right eyebrow can be also detected based on the facial contour image, and the makeup detection result is generated based on the symmetry result.

Here, edge detection is performed on the to-be-detected facial image to generate the facial contour image, which includes the contour information of each part on the face. The first contour information of the target part indicated by the facial mask image can represent the contour of the target part after the makeup, and the second contour information of the target part indicated by the facial mask image can represent the contour of the target part without makeup, so that after the deviation contour information is determined based on the first contour information and the second contour information, the makeup effect of the target part can be determined based on the deviation contour information, achieving the makeup detection of the target part such as the eyebrow part and the eyeline part.

In an optional implementation, in the step B3, the generating the makeup detection result of the target part based on the deviation contour information, specifically includes: determining a size value of the target part in a target direction based on the facial mask image; determining a ratio between a deviation value indicated by the deviation contour information and the size value; and generating the makeup detection result of the target part based on the ratio.

In implementation, it is possible to determine a size value of the target part in a target direction based on the facial mask image, for example, a length value in a length direction when the target part is an eyebrow. For example, for an eyeline part, a length value of the eyeline part in a horizontal direction (length direction) may be determined based on an abscissa value indicated by first coordinate information of a left eye corner and an abscissa value indicated by second coordinate information of a right eye corner. Then, a ratio between a deviation value indicated by the deviation contour information and the size value is determined. If the ratio is greater than a preset ratio threshold, the generated makeup detection result of the target part is that the makeup of the target part is abnormal, otherwise, the generated makeup detection result of the target part is that the makeup of the target part is normal.

Here, by determining the ratio between the deviation value indicated by the deviation contour information and the length value; based on the ratio, the makeup detection result of the target part can be determined more conveniently and efficiently.

Considering that the makeup process includes a base makeup process such as applying liquid foundation to a face region, and there is likely to be uneven application of the base makeup in the base makeup, the following detection process is provided to detect the above makeup abnormality effect.

In another manner, in a case where the target part includes a facial part other than five sense organs within a face, the detecting the makeup effect of the target part in the to-be-detected facial image based on the facial mask image and the to-be-detected facial image to obtain the makeup detection result of the target part, includes:
step C1, determining reference pixel information corresponding to the facial part based on the to-be-detected facial image and a mask region of the facial part indicated by the facial mask image;
step C2, determining abnormal pixel information characterizing a makeup abnormality state of the facial part based on the reference pixel information;
step C3, performing connected domain detection on the to-be-detected facial image based on the abnormal pixel information to determine whether the to-be-detected facial image comprises a connected domain; and
step C4, if the connected domain is included, generating a makeup detection result of the facial part based on region information of the connected domain on the to-be-detected facial image.

In implementation, the mask region of the facial part may be determined based on the facial mask image. Based on region information indicated by the mask region, a local image matched with the region information is determined from the to-be-detected facial image. And, based on pixel information of pixel points in the local image, the reference pixel information corresponding to the facial part is determined. For example, average pixel information of pixel information of pixel points in the local image may be determined, and the average pixel information is determined as the reference pixel information of the facial part.

The abnormal pixel information is determined based on the reference pixel information, for example, a pixel abnormality ratio may be set, the pixel abnormality ratio is multiplied by the reference pixel information to obtain an intermediate pixel value, and the intermediate pixel value is multiplied by the reference pixel information to obtain the abnormal pixel information.

Connected domain detection is performed on the to-be-detected facial image by using a connected domain detection algorithm based on the abnormal pixel information, to determine whether the to-be-detected facial image includes a connected domain. If the connected domain is included, the makeup detection result of the facial part is generated based on region information of the connected domain on the to-be-detected facial image. For example, if it is determined based on the region information of the connected domain that the connected domain is located on a left face, the generated makeup detection result of the facial part may be “uneven base makeup on the left face”.

In implementation, if the connected domain is not included, it is determined that the makeup of the facial part is normal, and the generated makeup detection result of the facial part is “normal makeup on the facial part”.

It may be determined whether the to-be-detected facial image includes the connected domain, a region corresponding to the connected domain may characterize a region with uneven base makeup on the facial part, if the connected domain is included, the makeup detection result of the facial part is generated based on the region information of the connected domain on the to-be-detected facial image, so as to detect the makeup effect of the facial part.

In the S104, when there is one target part, it is possible to determine the makeup detection result of the target part as prompt information, and then play the prompt information. Alternatively, it is possible to generate prompt information based on the makeup detection result of the target part. If the makeup detection result is “abnormal at the upper left corner of the lip”, the generated prompt information may be “it is out-of-bound at the upper left corner of the lip, please adjust the makeup of the lip”.

When there are a plurality of target parts, makeup detection results of the plurality of target parts may be determined as prompt information, and then the prompt information is played. Alternatively, prompt information may be generated based on makeup detection results of the plurality of target parts. If the makeup detection result of the lip part is “abnormal at the upper left corner of the lip” and the makeup detection result of the facial part is “normal makeup of the facial part”, the generated prompt information may be “it is out-of-bound at the upper left corner of the lip, please adjust the makeup of the lip”. If the makeup detection result of the lip part is “abnormal at the upper left corner of the lip” and the makeup detection result of the facial part is “uneven base makeup on the left face”, the generated prompt information may be “it is out-of-bound at the upper left corner of the lip, the base makeup on the left face is uneven, please adjust the makeup of the lip and the left face”.

In an optional implementation, after the obtaining the to-be-detected facial image, the method further includes: performing skin quality evaluation on the to-be-detected facial image to generate a skin detection result; and generating recommendation information based on the skin detection result, and playing the recommendation information.

In implementation, skin quality evaluation can be performed on the to-be-detected facial image to generate a target vector including a plurality of skin indicators; and the skin detection result is generated based on the target vector. For example, the skin indicators may include, but are not limited to, the number of pimples, the number of spots, a spot density, face smoothness, a pore size, and the like. Or, skin quality evaluation may be performed on the to-be-detected facial image by using a trained skin detection neural network, to obtain a skin detection result. The skin detection result may be, for example: “oily skin”, “sensitive skin”, “dry skin” and the like.

Recommendation information is generated based on the skin detection result and played, and the recommendation information can include, for example, a skin content, cosmetic type information, a makeup type, and the like.

Considering that the method can be applied to a vision-impaired person, a text-to-speech algorithm can be operated in the implementation of the method, text information displayed on a display screen of an execution subject is converted into speech information by using the text-to-speech algorithm, and the speech information is announced through a playing device.

Referring to a schematic diagram of an information prompt method shown in FIG. 4, the information prompt method is exemplarily described in conjunction with FIG. 4, the method including:
Step 1, acquiring an initial facial image of a target user.
Step 2, detecting the initial facial image by using a face calibration algorithm to determine whether a head region in the initial facial image is located within a preset region. That is, it is detected whether a face of the target user is directed at a camera.
Step 3, if so, playing makeup guidance information. The makeup guidance information may be used for guiding the user to paint an eyebrow, paint an eyeline, paint lipstick, paint blusher, and the like.

Here, if the head region in the initial facial image is not located within the preset region, it is possible to guide the user's face to be directed at the camera. For example, face guidance information may be generated and played to guide the target user's face to be directed at the camera.

Step 4, during playing the makeup guidance information or after finishing playing the makeup guidance information, obtaining a facial image of the target user to use the facial image as a to-be-detected facial image; and then, detecting the to-be-detected facial image by using a makeup correction module.

For example, makeup detection may be performed on the to-be-detected facial image by using a makeup correction algorithm to obtain a makeup detection result, and skin detection may be performed on the to-be-detected facial image by using a skin detection algorithm to obtain a skin detection result.

Step 5, generating prompt information based on the makeup detection result of the target part, and playing the prompt information, where the prompt information can be used for correcting the makeup of the target user. Recommendation information may also be generated based on the skin detection result and played, where the recommendation information can be used for making a skin suggestion to the target user.

Further, the obtained skin suggestion or a to-be-detected image without abnormal makeup effect may be shared and forwarded to other terminal devices, which can be terminal devices of other users or other devices of the target user.

In implementation, a VE SAMI text-to-speech algorithm can be operated in the whole information prompt process, and by using the text-to-speech algorithm, text information displayed on a display screen is converted into speech information in real time and announced.

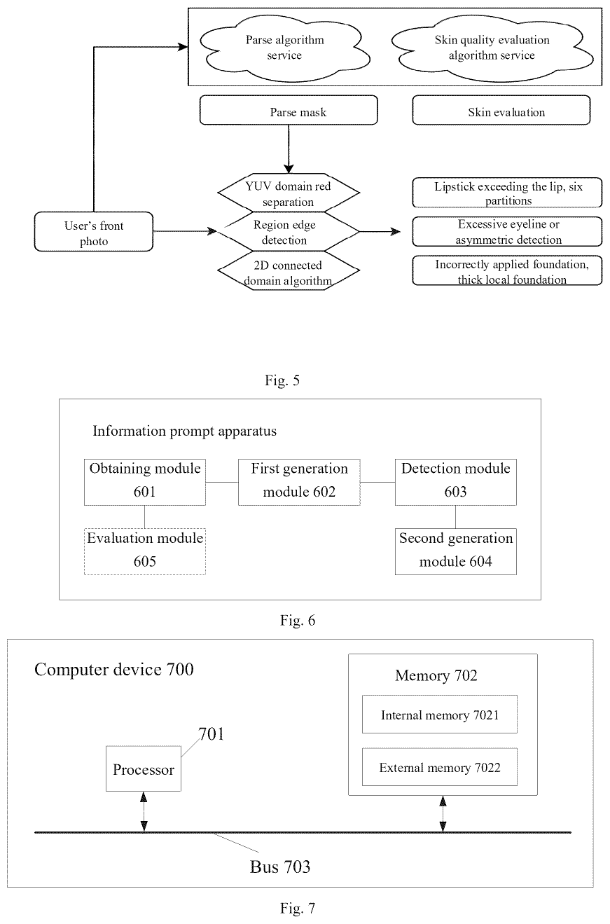

Referring to a work flow diagram of a makeup correction module shown in FIG. 5, an exemplary description in conjunction with FIG. 5 is made to a makeup effect detection process of a to-be-detected facial image, which specifically includes:
step 51, detecting a user's front face photo (i.e., the to-be-detected facial image) by calling a face parse algorithm service to obtain a face parse mask (i.e., the facial mask image).
Step 52, detecting a makeup effect of a lip part of the to-be-detected facial image by using a YUV domain red separation module to obtain a makeup detection result of the lip part.

For example, the makeup detection result may be “lipstick exceeding the lip, and target local region where the exceeding lipstick is located”, and the target local region may be one or more local regions in six partitions of the lip. Here, for the detection of the makeup effect of the lip part, reference may be made to the description with reference to the above steps A1 to A3, which will not be repeated here.

Step 53, detecting a makeup effect of an eyeline part of the to-be-detected facial image by using a face region edge detection module to obtain a makeup detection result of the eyeline part.

For example, the makeup detection result may be “excessive eyeline”, “asymmetric eyeline”, or the like. For the detection process of the eyebrow part, reference can be made to the detection process of the eyeline part. Here, for the detection of the makeup effects of the eyeline part and the eyebrow part, reference can be made to the description of the above steps B1 to B3, which will not be repeated here.

Step 54, detecting a makeup effect of a facial part of the to-be-detected facial image by using a two-dimensional (2D) connected domain algorithm module to obtain a makeup detection result of the facial part.

For example, the makeup detection result of the facial part may be “thickly applied foundation, thick local foundation”, or the like. For the detection of the makeup effect of the facial part, reference can be made to the description of the above steps C1 to C4, which will not be repeated here.

Step 55, skin evaluation may also be performed on the user's front face photo by calling a skin quality evaluation algorithm service to obtain a skin detection result of the user.

It can be understood by those of skill in the art that in specific implementations of the above method, the order of the steps does not imply a strict execution order to constitute any limitation on the implementation process, and the specific execution order of the steps should be determined by their functions and possibly inherent logic.

Based on the same inventive concept, an information prompt apparatus corresponding to the information prompt method is further provided in an embodiment of the present disclosure, and since the apparatus in the embodiment of the present disclosure has a similar principle for solving the problem to the information prompt method in the embodiment of the present disclosure, for the implementation of the apparatus, reference can be made to the implementation of the method, which will not be repeated.

Referring to FIG. 6, a schematic architecture diagram of an information prompt apparatus according to an embodiment of the present disclosure is shown, the apparatus including: an obtaining module 601, a first generation module 602, a detection module 603, and a second generation module 604, where
the obtaining module 601 is configured to obtain a to-be-detected facial image;
the first generation module 602 is configured to parse the to-be-detected facial image to generate a facial mask image;
the detection module 603 is configured to detect a makeup effect of a target part in the to-be-detected facial image based on the facial mask image and the to-be-detected facial image to obtain a makeup detection result of the target part; and
the second generation module 604 is configured to generate prompt information based on the makeup detection result of the target part, and play the prompt information.

In an optional implementation, in a case where the target part includes a lip part, the detection module 603, when detecting the makeup effect of the target part in the to-be-detected facial image based on the facial mask image and the to-be-detected facial image to obtain the makeup detection result of the target part, is configured to:
perform format conversion processing on the to-be-detected facial image to generate a processed facial image with a luminance chrominance format;
determine a target pixel point in the processed facial image that has pixel information matched with target color information, and determine region information of a to-be-detected region corresponding to a target color in the to-be-detected facial image based on a pixel position of the target pixel point; and
detect a makeup effect of the lip part in the to-be-detected facial image based on the region information of the to-be-detected region and mask region information corresponding to the lip part in the facial mask image to obtain a makeup detection result of the lip part.

In an optional implementation, the detection module 603, when detecting the makeup effect of the lip part in the to-be-detected facial image based on the region information of the to-be-detected region and the mask region information corresponding to the lip part in the facial mask image to obtain the makeup detection result of the lip part, is configured to:
determine whether a deviation region exists between the to-be-detected region and a mask region corresponding to the lip part based on the region information of the to-be-detected region and the mask region information corresponding to the lip part in the facial mask image;
if the deviation region exists, determine a target local region where the deviation region is located based on region information of the deviation region and region information of a plurality of local regions obtained by partitioning the lip part; and
generate the makeup detection result of the lip part based on region information of the target local region.

In an optional implementation, in a case where the target part includes an eyeline part and/or an eyebrow part, the detection module 603, when detecting the makeup effect of the target part in the to-be-detected facial image based on the facial mask image and the to-be-detected facial image to obtain the makeup detection result of the target part, is configured to:
perform edge detection on the to-be-detected facial image to generate a facial contour image, where the facial contour image indicates contour information of a facial part;
determine deviation contour information based on first contour information of the target part indicated by the facial contour image and second contour information of the target part indicated by the facial mask image; and
generate the makeup detection result of the target part based on the deviation contour information.

In an optional implementation, the detection module 603, when generating the makeup detection result of the target part based on the deviation contour information, is configured to:
determine a size value of the target part in a target direction based on the facial mask image;
determine a ratio between a deviation value indicated by the deviation contour information and the size value; and
generate the makeup detection result of the target part based on the ratio.

In an optional implementation, in a case where the target part includes a facial part other than five sense organs within a face, the detection module 603, when detecting the makeup effect of the target part in the to-be-detected facial image based on the facial mask image and the to-be-detected facial image to obtain the makeup detection result of the target part, is configured to:
determine reference pixel information corresponding to the facial part based on the to-be-detected facial image and a mask region of the facial part indicated by the facial mask image;
determine abnormal pixel information characterizing a makeup abnormality state of the facial part based on the reference pixel information;
perform connected domain detection on the to-be-detected facial image based on the abnormal pixel information to determine whether the to-be-detected facial image includes a connected domain; and
if the connected domain is included, generate a makeup detection result of the facial part based on region information of the connected domain on the to-be-detected facial image.

In an optional implementation, after the obtaining the to-be-detected facial image, the apparatus further includes: an evaluation module 605 configured to:
perform skin quality evaluation on the to-be-detected facial image to generate a skin detection result; and
generate recommendation information based on the skin detection result, and play the recommendation information.

In an optional implementation, the obtaining module 601, when the obtaining the to-be-detected facial image, is configured to:
acquire an initial facial image of a target user;
when a head region in the initial facial image is located within a preset region, play makeup guidance information; and
during playing the makeup guidance information or after finishing playing the makeup guidance information, obtain a facial image of the target user to use the facial image as the to-be-detected facial image.

For the description of the processing flows of the modules in the apparatus and the interaction flows between the modules, reference may be made to the related description in the above method embodiments, which will not be repeated here.

Based on the same technical concept, an embodiment of the present disclosure further provides a computer device. Referring to FIG. 7, it is a schematic structural diagram of a computer device 700 according to an embodiment of the present disclosure, the computer device 700 including a processor 701, a memory 702, and a bus 703. The memory 702 is configured to store execution instructions and includes an internal memory 7021 and an external memory 7022; and the internal memory 7021 here, also referred to as an internal storage, is configured to temporarily store operation data in the processor 701 and data exchanged with the external memory 7022 such as a hard disk, and the processor 701 exchanges data with the external memory 7022 via the internal memory 7021, and when the computer device 700 runs, the processor 701 communicates with the memory 702 via the bus 703, so that the processor 701 executes the following instructions:
obtaining a to-be-detected facial image;
parsing the to-be-detected facial image to generate a facial mask image;
detecting a makeup effect of a target part in the to-be-detected facial image based on the facial mask image and the to-be-detected facial image to obtain a makeup detection result of the target part; and
generating prompt information based on the makeup detection result of the target part, and playing the prompt information.

In a possible design, in the instructions executed by the processor 701, in a case where the target part includes a lip part, the detecting the makeup effect of the target part in the to-be-detected facial image based on the facial mask image and the to-be-detected facial image to obtain the makeup detection result of the target part, includes:
performing format conversion processing on the to-be-detected facial image to generate a processed facial image with a luminance chrominance format;
determining a target pixel point in the processed facial image that has pixel information matched with target color information, and determining region information of a to-be-detected region corresponding to a target color in the to-be-detected facial image based on a pixel position of the target pixel point; and
detecting a makeup effect of the lip part in the to-be-detected facial image based on the region information of the to-be-detected region and mask region information corresponding to the lip part in the facial mask image to obtain a makeup detection result of the lip part.

In a possible design, in the instructions executed by the processor 701, the detecting the makeup effect of the lip part in the to-be-detected facial image based on the region information of the to-be-detected region and the mask region information corresponding to the lip part in the facial mask image to obtain the makeup detection result of the lip part, includes:
determining whether a deviation region exists between the to-be-detected region and a mask region corresponding to the lip part based on the region information of the to-be-detected region and the mask region information corresponding to the lip part in the facial mask image;
if the deviation region exists, determining a target local region where the deviation region is located based on region information of the deviation region and region information of a plurality of local regions obtained by partitioning the lip part; and
generating the makeup detection result of the lip part based on region information of the target local region.

In a possible design, in the instructions executed by the processor 701, in a case where the target part includes an eyeline part and/or an eyebrow part, the detecting the makeup effect of the target part in the to-be-detected facial image based on the facial mask image and the to-be-detected facial image to obtain the makeup detection result of the target part, includes:
performing edge detection on the to-be-detected facial image to generate a facial contour image, where the facial contour image indicates contour information of a facial part;
determining deviation contour information based on first contour information of the target part indicated by the facial contour image and second contour information of the target part indicated by the facial mask image; and
generating the makeup detection result of the target part based on the deviation contour information.

In a possible design, in the instructions executed by processor 701, the generating the makeup detection result of the target part based on the deviation contour information, includes:
determining a size value of the target part in a target direction based on the facial mask image;
determining a ratio between a deviation value indicated by the deviation contour information and the size value; and
generating the makeup detection result of the target part based on the ratio.

In a possible design, in the instructions executed by the processor 701, in a case where the target part includes a facial part other than five sense organs within a face, the detecting the makeup effect of the target part in the to-be-detected facial image based on the facial mask image and the to-be-detected facial image to obtain the makeup detection result of the target part, includes:
determining reference pixel information corresponding to the facial part based on the to-be-detected facial image and a mask region of the facial part indicated by the facial mask image;
determining abnormal pixel information characterizing a makeup abnormality state of the facial part based on the reference pixel information;
performing connected domain detection on the to-be-detected facial image based on the abnormal pixel information to determine whether the to-be-detected facial image comprises a connected domain; and
if the connected domain is included, generating a makeup detection result of the facial part based on region information of the connected domain on the to-be-detected facial image.

In a possible design, in the instructions executed by the processor 701, after the obtaining the to-be-detected facial image, the method further includes:
performing skin quality evaluation on the to-be-detected facial image to generate a skin detection result; and
generating recommendation information based on the skin detection result, and playing the recommendation information.

In a possible design, in the instructions executed by the processor 701, the obtaining the to-be-detected facial image, includes:
acquiring an initial facial image of a target user;
when a head region in the initial facial image is located within a preset region, playing makeup guidance information; and
during playing the makeup guidance information or after finishing playing the makeup guidance information, obtaining a facial image of the target user to use the facial image as the to-be-detected facial image.

An embodiment of the present disclosure further provides a computer-readable storage medium having thereon stored a computer program which, when executed by a processor, performs the steps of the information prompt method according to the above method embodiments. The storage medium may be a volatile or non-volatile computer-readable storage medium.

An embodiment of the present disclosure further provides a computer program product or computer program having therein carried program code, instructions included in the program code being usable for performing the steps of the information prompt method according to the above method embodiments, for which reference may be specifically made to the above method embodiments, which will not be repeated here.

The above computer program product may be specifically implemented by hardware, software or a combination thereof. In an optional embodiment, the computer program product is embodied as a computer storage medium, and in another optional embodiment, the computer program product is embodied as a software product, such as a software development kit (SDK).

It can be clearly understood by those skilled in the art that, for convenience and simplicity of the description, for the specific working processes of the system and the apparatus described above, reference may be made to the corresponding processes in the foregoing method embodiments, which are not repeated here. In the several embodiments provided in the present disclosure, it should be understood that the disclosed system, apparatus and method may be implemented in other ways. The apparatus embodiment described above is merely illustrative, for example, the division of the units is only a logical function division, and there may be another division in an actual implementation, and for another example, a plurality of units or components may be combined or integrated into another system, or some features may be omitted, or not executed. On the other hand, the shown or discussed coupling or direct coupling or communication connection between each other may be, through some communication interfaces, indirect coupling or communication connection between devices or units, which may be in an electrical, mechanical or other form.

The units described as separate components may or may not be physically separated, and the components displayed as units may or may not be physical units, that is, they may be located in one place, or may be distributed onto a plurality of network units. Some or all of the units can be selected according to actual needs to achieve the purpose of the solution of this embodiment.

In addition, the functional units in the embodiments of the present disclosure may be integrated into one processing unit, or each unit may exist alone physically, or two or more units are integrated into one unit.

The functions, if implemented in a form of a software function unit and sold or used as a stand-alone product, may be stored in one non-volatile computer-readable storage medium executable by a processor. Based on such understanding, the technical solutions of the present disclosure in essence, or the portion contributing to the related art, or the portion of the technical solution, may be embodied in a form of a software product, which is stored in one storage medium and includes several instructions for causing one computer device (which may be a personal computer, a server, a network device, or the like) to execute all or some of the steps of the method according to the embodiments of the present disclosure. The above storage medium includes: various media that can store program code, such as a USB flash disk, a mobile hard disk, a read-only memory (ROM), a random access memory (RAM), a magnetic disk, or an optical disk.

Finally, it should be noted that: the above embodiments are merely specific implementations of the present disclosure, which are used for illustrating the technical solutions of the present disclosure, rather than limiting them, so that the protection scope of the present disclosure is not limited thereto; although the present disclosure is described in detail with reference to the foregoing embodiments, one of ordinary skill in the art should understand that: anyone skilled in the art can, within the technical scope disclosed in the present disclosure, still make modifications or easily thinkable changes to the technical solutions described in the foregoing embodiments, or make equivalent substitutions for some of the technical features therein; and these modifications, changes and substitutions do not make the essence of the corresponding technical solution depart from the spirit and scope of the technical solutions of the embodiments of the present disclosure, and should all be covered within the protection scope of the present disclosure. Therefore, the protection scope of the present disclosure should be subject to the protection scope of the claims.

What is claimed is:

1. An information prompt method, comprising:
obtaining a to-be-detected image;
parsing the to-be-detected image to generate a mask image;
detecting a makeup effect of a target part in the to-be-detected image based on the mask image and the to-be-detected image to obtain a makeup detection result of the target part; and
generating prompt information based on the makeup detection result of the target part, and playing the prompt information.

2. The method according to claim 1, wherein, in response to the target part comprising a lip part, the detecting the makeup effect of the target part in the to-be-detected image based on the mask image and the to-be-detected image to obtain the makeup detection result of the target part, comprises:
performing format conversion processing on the to-be-detected image to generate a processed image with a luminance chrominance format;
determining a target pixel point in the processed image that has pixel information matched with target color information, and determining region information of a to-be-detected region corresponding to a target color in the to-be-detected image based on a pixel position of the target pixel point; and
detecting a makeup effect of the lip part in the to-be-detected image based on the region information of the to-be-detected region and mask region information corresponding to the lip part in the mask image to obtain a makeup detection result of the lip part.

3. The method according to claim 2, wherein the detecting the makeup effect of the lip part in the to-be-detected image based on the region information of the to-be-detected region and the mask region information corresponding to the lip part in the mask image to obtain the makeup detection result of the lip part, comprises:
determining whether a deviation region exists between the to-be-detected region and a mask region corresponding to the lip part based on the region information of the to-be-detected region and the mask region information corresponding to the lip part in the mask image;
in response to that the deviation region exists, determining a target local region where the deviation region is located based on region information of the deviation region and region information of a plurality of local regions obtained by partitioning the lip part; and
generating the makeup detection result of the lip part based on region information of the target local region.

4. The method according to claim 1, wherein, in response to the target part comprising at least one of an eyeline part or an eyebrow part, the detecting the makeup effect of the target part in the to-be-detected image based on the mask image and the to-be-detected image to obtain the makeup detection result of the target part, comprises:
performing edge detection on the to-be-detected image to generate a contour image, wherein, the contour image indicates contour information of a part;
determining deviation contour information based on first contour information of the target part indicated by the contour image and second contour information of the target part indicated by the mask image; and
generating the makeup detection result of the target part based on the deviation contour information.

5. The method of claim 4, wherein the generating the makeup detection result of the target part based on the deviation contour information, comprises:
determining a size value of the target part in a target direction based on the mask image;
determining a ratio between a deviation value indicated by the deviation contour information and the size value; and
generating the makeup detection result of the target part based on the ratio.

6. The method according to claim 1, wherein, in response to the target part comprising a part other than five sense organs within a face, the detecting the makeup effect of the target part in the to-be-detected image based on the mask image and the to-be-detected image to obtain the makeup detection result of the target part, comprises:
determining reference pixel information corresponding to the part based on the to-be-detected image and a mask region of the part indicated by the mask image;
determining abnormal pixel information characterizing a makeup abnormality state of the part based on the reference pixel information;
performing connected domain detection on the to-be-detected image based on the abnormal pixel information to determine whether the to-be-detected image comprises a connected domain; and
in response to that the connected domain is comprised, generating a makeup detection result of the part based on region information of the connected domain on the to-be-detected image.

7. The method according to claim 1, wherein after the obtaining the to-be-detected image, the method further comprises:
performing skin quality evaluation on the to-be-detected image to generate a skin detection result; and
generating recommendation information based on the skin detection result, and playing the recommendation information.

8. The method according to claim 1, wherein the obtaining the to-be-detected image, comprises:
acquiring an initial image of a target user;
in response to a head region in the initial image being located within a preset region, playing makeup guidance information;
during playing the makeup guidance information or after finishing playing the makeup guidance information, obtaining an image of the target user to use the image as the to-be-detected image.

9. A computer device, comprising: a processor, a memory and a bus, the memory having thereon stored machine-readable instructions executable by the processor, the processor and the memory communicating via the bus when the computer device runs, and the machine-readable instructions, when executed by the processor, implementing an information prompt method,
obtaining a to-be-detected image;
parsing the to-be-detected image to generate a mask image;
detecting a makeup effect of a target part in the to-be-detected image based on the mask image and the to-be-detected image to obtain a makeup detection result of the target part; and
generating prompt information based on the makeup detection result of the target part, and playing the prompt information.

10. A non-transitory computer-readable storage medium having thereon stored a computer program which, when executed by a processor, implement an information prompt method,
obtaining a to-be-detected image;
parsing the to-be-detected image to generate a mask image;
detecting a makeup effect of a target part in the to-be-detected image based on the mask image and the to-be-detected image to obtain a makeup detection result of the target part; and
generating prompt information based on the makeup detection result of the target part, and playing the prompt information.

11. The non-transitory computer-readable storage medium according to claim 10, wherein, in response to the target part comprising a lip part, the detecting the makeup effect of the target part in the to-be-detected image based on the mask image and the to-be-detected image to obtain the makeup detection result of the target part, comprises:
performing format conversion processing on the to-be-detected image to generate a processed image with a luminance chrominance format;
determining a target pixel point in the processed image that has pixel information matched with target color information, and determining region information of a to-be-detected region corresponding to a target color in the to-be-detected image based on a pixel position of the target pixel point; and
detecting a makeup effect of the lip part in the to-be-detected image based on the region information of the to-be-detected region and mask region information corresponding to the lip part in the mask image to obtain a makeup detection result of the lip part.

12. The non-transitory computer-readable storage medium according to claim 11, wherein the detecting the makeup effect of the lip part in the to-be-detected image based on the region information of the to-be-detected region and the mask region information corresponding to the lip part in the mask image to obtain the makeup detection result of the lip part, comprises:
determining whether a deviation region exists between the to-be-detected region and a mask region corresponding to the lip part based on the region information of the to-be-detected region and the mask region information corresponding to the lip part in the mask image;
in response to that the deviation region exists, determining a target local region where the deviation region is located based on region information of the deviation region and region information of a plurality of local regions obtained by partitioning the lip part; and
generating the makeup detection result of the lip part based on region information of the target local region.

13. The non-transitory computer-readable storage medium according to claim 10, wherein, in response to the target part comprising at least one of an eyeline part or an eyebrow part, the detecting the makeup effect of the target part in the to-be-detected image based on the mask image and the to-be-detected image to obtain the makeup detection result of the target part, comprises:
performing edge detection on the to-be-detected image to generate a contour image, wherein, the contour image indicates contour information of a part;
determining deviation contour information based on first contour information of the target part indicated by the contour image and second contour information of the target part indicated by the mask image; and
generating the makeup detection result of the target part based on the deviation contour information.

14. The non-transitory computer-readable storage medium according to claim 13, wherein the generating the makeup detection result of the target part based on the deviation contour information, comprises:
determining a size value of the target part in a target direction based on the mask image;
determining a ratio between a deviation value indicated by the deviation contour information and the size value; and
generating the makeup detection result of the target part based on the ratio.

15. The non-transitory computer-readable storage medium according to claim 10, wherein, in response to the target part comprising a part other than five sense organs within a face, the detecting the makeup effect of the target part in the to-be-detected image based on the mask image and the to-be-detected image to obtain the makeup detection result of the target part, comprises:
determining reference pixel information corresponding to the part based on the to-be-detected image and a mask region of the part indicated by the mask image;
determining abnormal pixel information characterizing a makeup abnormality state of the part based on the reference pixel information;
performing connected domain detection on the to-be-detected image based on the abnormal pixel information to determine whether the to-be-detected image comprises a connected domain; and
in response to that the connected domain is comprised, generating a makeup detection result of the part based on region information of the connected domain on the to-be-detected image.

16. The non-transitory computer-readable storage medium according to claim 10, wherein after the obtaining the to-be-detected image, the method further comprises:
performing skin quality evaluation on the to-be-detected image to generate a skin detection result; and
generating recommendation information based on the skin detection result, and playing the recommendation information.

17. The non-transitory computer-readable storage medium according to claim 10, wherein the obtaining the to-be-detected image, comprises:
acquiring an initial image of a target user;
in response to a head region in the initial image being located within a preset region, playing makeup guidance information;
during playing the makeup guidance information or after finishing playing the makeup guidance information, obtaining an image of the target user to use the image as the to-be-detected image.

18. The computer device according to claim 9, wherein, in response to the target part comprising a lip part, the detecting the makeup effect of the target part in the to-be-detected image based on the mask image and the to-be-detected image to obtain the makeup detection result of the target part, comprises:
performing format conversion processing on the to-be-detected image to generate a processed image with a luminance chrominance format;
determining a target pixel point in the processed image that has pixel information matched with target color information, and determining region information of a to-be-detected region corresponding to a target color in the to-be-detected image based on a pixel position of the target pixel point; and
detecting a makeup effect of the lip part in the to-be-detected image based on the region information of the to-be-detected region and mask region information corresponding to the lip part in the mask image to obtain a makeup detection result of the lip part.

19. The computer device according to claim 18, wherein the detecting the makeup effect of the lip part in the to-be-detected image based on the region information of the to-be-detected region and the mask region information corresponding to the lip part in the mask image to obtain the makeup detection result of the lip part, comprises:
determining whether a deviation region exists between the to-be-detected region and a mask region corresponding to the lip part based on the region information of the to-be-detected region and the mask region information corresponding to the lip part in the mask image;
in response to that the deviation region exists, determining a target local region where the deviation region is located based on region information of the deviation region and region information of a plurality of local regions obtained by partitioning the lip part; and
generating the makeup detection result of the lip part based on region information of the target local region.

20. The computer device according to claim 9, wherein, in response to the target part comprising at least one of an eyeline part or an eyebrow part, the detecting the makeup effect of the target part in the to-be-detected image based on the mask image and the to-be-detected image to obtain the makeup detection result of the target part, comprises:
performing edge detection on the to-be-detected image to generate a contour image, wherein, the contour image indicates contour information of a part;
determining deviation contour information based on first contour information of the target part indicated by the contour image and second contour information of the target part indicated by the mask image; and
generating the makeup detection result of the target part based on the deviation contour information.
